(19) United States
(12) Patent Application Publication
(10) Pub. No.: US 2025/0377834 A1
(43) Pub. Date: Dec. 11, 2025

(54) PREDICTIVE TRANSFER DATA REGISTER IN MULTIPLANE CACHE READ

(71) Applicant: Micron Technology, Inc., Boise, ID (US)

(72) Inventor: Wenjun Wu, Shanghai (CN)

(21) Appl. No.: 19/229,698

(22) Filed: Jun. 5, 2025

Related U.S. Application Data
(60) Provisional application No. 63/658,596, filed on Jun. 11, 2024.

(51) Int. Cl. G06F 3/06

(52) U.S. Cl. CPC G06F 3/0659; G06F 3/0604; G06F 3/0679

(57) ABSTRACT

Methods, systems, and devices for predictive transfer NAND data register in multiplane cache read are described. A memory device may obtain, from memory after transferring a first set of data from a first set of latches to a second set of latches, a second set of data, where obtaining the second set of data includes loading the second set of data into the first set of latches. The memory device may initialize a counter based on receiving a quantity of commands and may transmit the first set of data from the second set of latches. The memory device may update the counter based on a quantity of the first set of data transmitted subsequent to initializing the counter and may transfer the second set of data from the first set of latches to the second set of latches based on the counter satisfying a threshold.

### CROSS REFERENCE

The present Application for Patent claims priority to U.S. Provisional Patent Application No. 63/658,596 by Wu, entitled “PREDICTIVE TRANSFER DATA REGISTER IN MULTIPLANE CACHE READ,” filed Jun. 11, 2024, which is assigned to the assignee hereof, and which is expressly incorporated by reference in its entirety herein.

### TECHNICAL FIELD

The following relates to one or more systems for memory, including predictive transfer data register in multiplane cache read.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states after being disconnected from an external power source.

### BRIEF DESCRIPTION OF THE DRAWINGS

FIG. 1 shows an example of a system that supports predictive transfer data register in multiplane cache read in accordance with examples as disclosed herein.

FIG. 2 shows an example of a memory system that supports predictive transfer data register in multiplane cache read in accordance with examples as disclosed herein.

FIG. 3 shows an example of a timing diagram that supports predictive transfer data register in multiplane cache read in accordance with examples as disclosed herein.

FIG. 4 shows a block diagram of a memory system that supports predictive transfer data register in multiplane cache read in accordance with examples as disclosed herein.

FIG. 5 shows a flowchart illustrating a method or methods that support predictive transfer data register in multiplane cache read in accordance with examples as disclosed herein.

### DETAILED DESCRIPTION

A memory device may transfer a page of data associated with multiple planes to another device (e.g., a memory system controller, a host device) in a multi-plane operation. For purposes of this application, a multi-plane operation may be defined as a memory operation (e.g., a memory read or write) associated with multiple planes of memory. A page of data associated with a multi-plane operation may be referred to herein as a multi-plane page or a page. The page may comprise portions of data associated with each plane of the operation, which may be referred to herein as an associated page of the plane. For example, for a multi-plane page of data associated with a two-plane operation, a portion of the page may be associated with one of the planes (e.g., an associated page of a first plane) and another portion of the page may be associated with the other plane (e.g., an associated page of a second plane).

In examples in which the transfer of the page of data is performed as part of a read operation, the memory device may provide the portions of data associated with each plane to a set of buffer latches (e.g., to one or more data registers), where the set of buffer latches may be configured to pass data internally (e.g., to and from a memory array of the memory device). Once the data is transferred to the set of buffer latches, the set of buffer latches may provide the data to a set of gateway latches (e.g., to one or more cache registers), where the set of gateway latches may be configured to pass data externally (e.g., to and from a memory system controller). For instance, the memory device may receive a cache command and may transfer the data to the set of gateway latches in response to receiving the cache command. The transferring of data associated with a page between gateway latches and buffer latches may take a particular amount of time (a delay time) to complete. The delay time may include, e.g., time for the data to settle, time to perform the latching of the data, etc., and may be in an order of about 2 microseconds or more.

Once the data is provided to the set of gateway latches, the set of gateway latches may transmit the data. To transmit the data, the memory device may receive a set of transfer commands, where each transfer command indicates to transmit a respective portion of data for a respective plane from the set of gateway latches. After a last transfer command of the set of transfer commands is received for a last plane of the multiple planes and the corresponding portion of data for the last plane is transmitted, the set of gateway latches may receive a next cache command and may correspondingly transfer new data from the set of buffer latches to the set of gateway latches.

In current memory systems, a wait time may be introduced between the transmission of each page of data to take into account the delay time and ensure the internal transfer of the page is completed between the latches. In some examples, the wait time may begin after a cache command is received. Reducing the wait time following reception of a cache command may enable faster data transfers and higher throughput, including for multi-plane operations.

Techniques are described for predictive transfer to gateway latches in a multiplane cache read. For instance, after the command for the last plane of the multiple planes is received by the memory device, the memory device may initialize a counter, where the counter may track a quantity of data for the last plane transmitted from the set of gateway latches. Upon the quantity of data reaching a threshold amount, the memory device may initiate the wait time associated with transferring data from the set of buffer latches to the set of gateway latches. If the quantity of data reaches the threshold amount before the next cache command is received, then the wait time may start before the cache command is received. Thus, a remaining portion of the wait time that occurs after receiving the cache command may be reduced as compared to performing the transferring after receiving the cache command. Transferring from the set of buffer latches to the set of gateway latches where the wait time begins prior to receiving the cache read command may be referred to as predictive transferring.

In addition to applicability in memory systems as described herein, techniques for predictive transfer for a data register in a multiplane cache read may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing a wait time between the memory device receiving a cache command and the corresponding transfer from the buffer latches to the gateway latches to be complete, among other benefits.

Features of the disclosure are illustrated and described in the context of systems, devices, and circuits. Features of the disclosure are further illustrated and described in the context of a timing diagram and flowcharts.

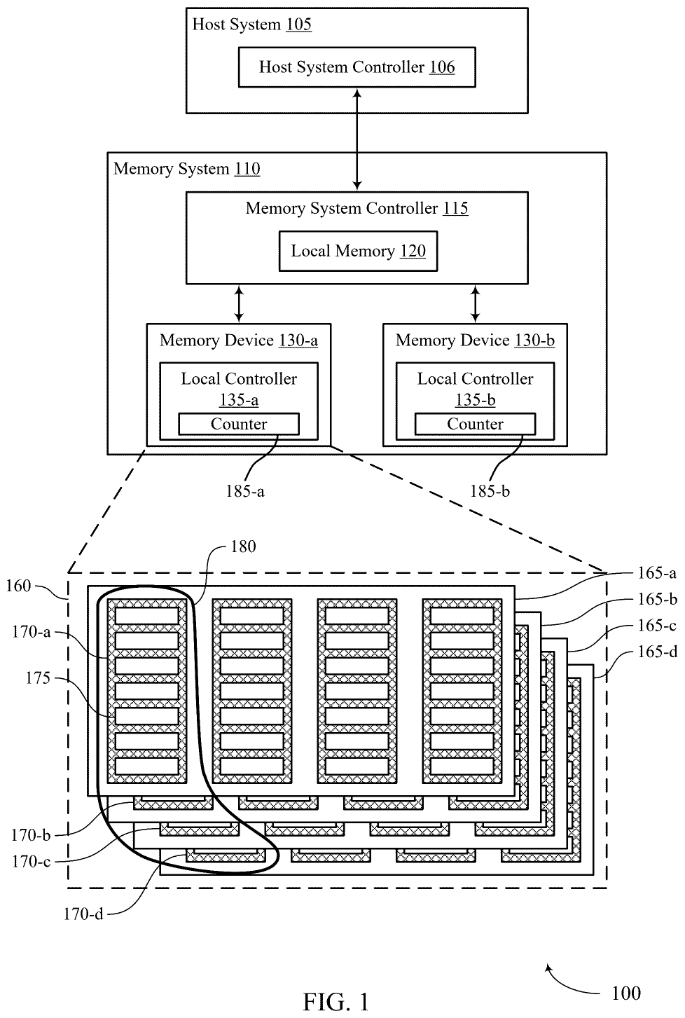

FIG. 1 shows an example of a system 100 that supports predictive transfer data register in multiplane cache read in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support predictive transfer data register in multiplane cache read. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In addition to applicability in memory systems as described herein, techniques for multi-plane cache transfer enhancement may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices, among other benefits.

In some examples, local controller 135-a may have a counter 185-a and local controller 135-b may have a counter 185-b. Counters 185-a and 185-b may enable predictive transfer in a multiplane cache read as described herein. For instance, in examples in which memory device 130-a is providing a multi-plane page during a read operation, memory device 130-a may receive a set of transfer commands for each plane associated with the multi-plane page. When a transfer command for a last plane is received, memory device 130-a may initialize counter 185-a and may adjust counter 185-a according to an amount of data for the last plane that is transferred to memory system controller 115. When the adjusted value satisfies a threshold amount, memory device 130-a may initiate a wait time for transferring a next page from one or more data registers to one or more cache registers. This wait time may be initiated prior to receiving a cache command for the next page. It should be noted that the counter 185-a or 185-b may, in some cases, be included in a separate component (e.g., a separate controller) from local controller 135-a or 135-b, respectively.

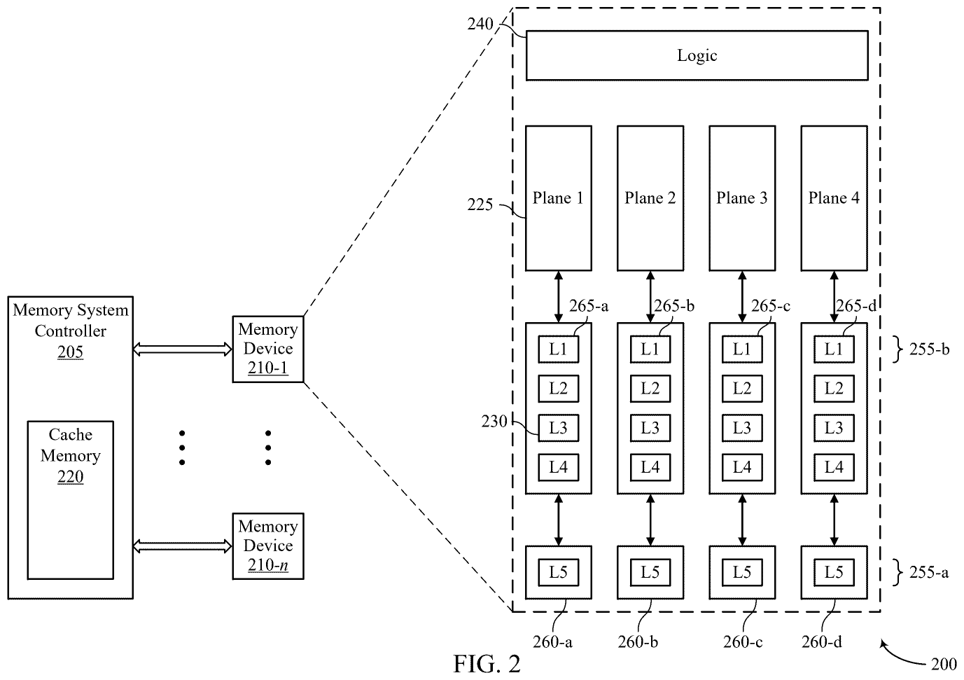

FIG. 2 shows an example of a memory system 200 that supports multi-plane cache transfer enhancement in accordance with examples as disclosed herein. The memory system 200 may be an example of a memory system 110 as described with reference to FIG. 1, or aspects thereof. The memory system 200 may include a memory system controller 205 coupled with one or more memory devices 210 (e.g., memory device 210-1 through 210-n) over one or more communication channels (e.g., one or more ONFI channels). The memory system controller 205 may have a cache memory 220, e.g., for temporarily storing data transferred between the host system and the memory devices 210. Memory system controller 205 may be an example of memory system controller 115 discussed with respect to FIG. 1. Cache memory 220 may be an example of or included in local memory 120 discussed with respect to FIG. 1. The memory devices 210 may be examples of the memory devices 130 discussed with respect to FIG. 1.

The memory system 200 may be configured to store data received from a host system and to send data to the host system, in response to a request by the host system using access commands (e.g., read commands or write commands). Memory system controller 205 may execute commands (e.g., access commands) received from the host system and control the movement of information (e.g., data, address mapping information) within the memory system 200. For example, memory system controller 205 may manage the transfer of information to and from the memory devices 210, e.g., for storing information, retrieving information, and determining memory locations in which to store information and from which to retrieve information.

The memory devices 210 may store data transferred between the memory system 200 and the host system, e.g., in response to receiving access commands from the host system. A memory device 210 may include N planes 225 (e.g., four planes, denoted plane 1 through plane 4 in the depicted example). Each plane 225 may have one or more associated latches 230 (denoted L1 through L5 in the depicted embodiment). The latches 230 may facilitate access operations (e.g., read operations, write operations) by temporarily storing data involved in the access operations. Each of the latches 230 may include multiple latch circuits, each capable of storing a single bit, such that each of the latches 230 may store a quantity of bits corresponding to a page of the corresponding plane 225. The latch circuits may be implemented in the memory device as either level-triggered (e.g., transparent latches) or edge-triggered (e.g., flip-flops). Although described as having five latches 230 associated with each plane, some memory devices may have fewer or more latches 230 associated with a plane. In some cases, each memory device 210 may include m+1 latches 230 associated with a plane, where m may represent a quantity of bits stored in a memory cell at a highest supported density (e.g., highest quantity of bits stored in each of the multiple-level memory cells). For example, for a plane 225 having QLC memory cells, there may be five latches, and for a plane 225 having TLC memory cells, there may be four latches.

In some examples, one or more of the latches 230 associated with a plane 225 (e.g., latch L5), may serve as a gateway latch for passing data to and from memory system controller 205 (e.g., gateway latches 260-a, 260-b, 260-c, and 260-d). In some examples, one or more of the latches 230 associated with the plane (e.g., one or more of latches L1-L4) may each serve as a buffer latch for passing data to and from the memory cells of the plane (e.g., buffer latches 265-a, 265-b, 265-c, and 265-d). In some examples, the gateway latch and the buffer latches may be coupled so that data sent to or received from memory system controller is routed through the gateway latch and a buffer latch (e.g., gateway latches 260-a coupled with buffer latches 265-a, gateway latches 260-b coupled with buffer latches 265-b, and so on).

Data transferred from the memory system controller 205 to the memory cells associated with a plane 225 (e.g., as part of a write command) may be routed, in order, through a gateway latch and a buffer latch associated with the plane before being written to the memory cells of the plane. Conversely, data transferred from the memory cells of a plane 225 to the memory system controller 205 (e.g., as part of a read command) may be routed, in order, through a buffer latch and a gateway latch before being transmitted to the memory system controller 205.

The latches 230 associated with the planes 225 may be organized into sets of latches 255. For example, latches L5 of all of the planes 225 may together comprise a set of latches 255-a, latches L1 of all of the planes 225 may together comprise another set of latches 255-b, and so forth.

During write and read operations of pages associated with multiple planes, the portions of the pages associated with each plane may be received or transmitted a plane at a time. For example, during a read operation, the portion of the page associated with a first plane may be transmitted to the memory system controller before the portion associated with the second plane, and so forth.

In some examples, the logic 240 may determine which planes and subset of planes to use based on (e.g., in response to) the commands received from the memory system controller. For example, a specific command received from the memory system controller may indicate a respective plane or set of planes to use for transmitting or receiving the data.

For read operations, the memory device may read data from the planes 225 into buffer latches. The memory device may transfer the data from the buffer latches to gateway latches for temporary storage until the data may be transmitted to the memory system controller, a plane at a time.

During a read operation, the memory device may provide the portions of data associated with each plane 225 to the buffer latches (e.g., one or more data registers). Once the data is transferred to the buffer latches, the buffer latches may provide the data to gateway latches (e.g., one or more cache registers). For instance, the memory device may receive a cache command (e.g., 31h) and may transfer the data to the gateway latches in response to receiving the cache command. The transferring of data associated with a page between gateway latches and buffer latches may take a particular amount of time (a delay time) to complete. The delay time may include, e.g., time for the data to settle, time to perform the latching of the data, etc., and may be in an order of about 2 microseconds or more.

Once the data is provided to the gateway latches, the gateway latches may transmit the data. To transmit the data, the memory device may receive a set of transfer commands (e.g., 06h), where each transfer command indicates to transmit a respective portion of data for a respective plane 225 from the gateway latches. After a last transfer command of the set of transfer commands is received for a last plane 225 of the multiple planes and the corresponding portion of data for the last plane 225 is transmitted, the gateway latches may receive a next cache command and may correspondingly transfer new data from the buffer latches to the gateway latches.

In current memory systems, a wait time (e.g., t_{RCBSY}) may be introduced between the transmission of each page of data to take into account the delay time and ensure the internal transfer of the page is completed between the latches. In some examples, t_{RCBSY} may be defined as an overhead of a NAND controller to move data from a data register to a cache register, after which a host device may read the data from the cache register. Additionally, t_{RCBSY} may take a predefined amount of time (e.g., 2 microseconds). In some examples, the wait time may begin after a cache command is received. Reducing the wait time following reception of a cache command may enable faster data transfers and higher throughput, including for multi-plane operations. For instance, bandwidth may be limited based on (e.g., dependent on) an ONFI workload and t_{RCBSY} may be an ONFI overhead that impacts NAND throughput. One method to reduce t_{RCBSY} may include implementing a high NAND capability on memory transfer speed. Another technique may include triggering a data register to move data at a beginning of a cache read command, where the moving of data may overlap with the command. Reducing a command transfer time may result in less overlap with t_{RCBSY}.

Techniques are described for predictive transfer to gateway latches in a multiplane cache read. For instance, after the command for the last plane of the multiple planes 225 is received by the memory device, the memory device may initialize a counter, where the counter may track a quantity of data for the last plane 225 transmitted from the gateway latches. Upon the quantity of data reaching a threshold amount, the memory device may initiate the wait time associated with transferring data from the buffer latches to the gateway latches. If the quantity of data reaches the threshold amount before the next cache command is received, then the wait time may start before the cache command is received. Thus, a remaining portion of the wait time that occurs after receiving the cache command may be reduced as compared to performing the transferring after receiving the cache command. In some examples, initiating the wait time in this manner may enable data moving from a data register to a cache register to be triggered after previous data transferring is nearly done (e.g., within a threshold amount of being finished).

A host device may set one or more threshold values for the counter (e.g., T[x], where x may range from zero to a non-zero integer) after a NAND is initialized. After the NAND receives the last plane's transfer command (e.g., a change read column command), the counter may be initialized with a size of data that the host has requested to read (e.g., a page size, 16 KB). Upon a memory controller (e.g., a direct memory access (DMA) controller) transferring data to a host device (e.g., or memory system controller), the counter may be decreased by the amount of data that has been transferred. After a remaining value of the counter is less than one of the preset threshold values (e.g., T[0]), the NAND may initiate the wait time (e.g., may begin transferring data from the data register to the cache register and/or from buffer latches to gateway latches). The value of T[0] may be such that remaining data in the cache register and/or the buffer latches is transferred to the host device before NAND overwrites the cache register for the last plane. Such a setting (e.g., a safe setting) may be based on (e.g., dependent on) a NAND cache register copy speed and/or an ONFI speed. In some examples, the threshold value may be zero (0) such that the wait time (e.g., transfer from buffer latches to the gateway latches) is initiated once all the data from the last plane has been read from the cache register.

The memory device may determine that the transfer command for the last plane corresponds to the last plane based on (e.g., in direct response to) the command being specific to the last plane (e.g., being an 08-Addr-E0h command instead of an 06-Addr-E0h command). For instance, if there are 6 planes of data to be read, an 06h command may be used for planes 0 to plane 4 and an 08h command may be used for a last plane (e.g., plane 5). It should be noted that 08h is an example and that any spare (e.g., reserved) command number may accomplish the same purpose. Alternatively, the memory device may determine that the transfer command for the last plane corresponds to the last plane based on (e.g., in direct response to) a reserved bit in the Addr to indicate that the transfer command is for the last plane. For instance, the command of the last plane may be 06h-Addr_with_bit_set-E0h. To calibrate appropriate counter threshold values for T[x], T[x] may be calculated according to an ONFI speed (e.g., which impacts data transfer time), t_{RCBSY}, t_{wc} (e.g., which impacts command transfer time), an application-specific integrated circuit (ASIC) command overhead, or a combination thereof.

The techniques described herein may be associated with one or more advantages. For instance, the techniques described herein may enable a reduced wait time after a cache read command for transmitting data from gateway latches. Additionally, or alternatively, the techniques described herein may be used for a variety of ONFI speeds and t_{RCBSY} values (e.g., any ONFI speed and any t_{RCBSY} value) and may enable a more flexible constraint on t_{RCBSY}, which may reduce NAND ASIC controller maximum frequency, memory bandwidth, peak power, or a combination thereof.

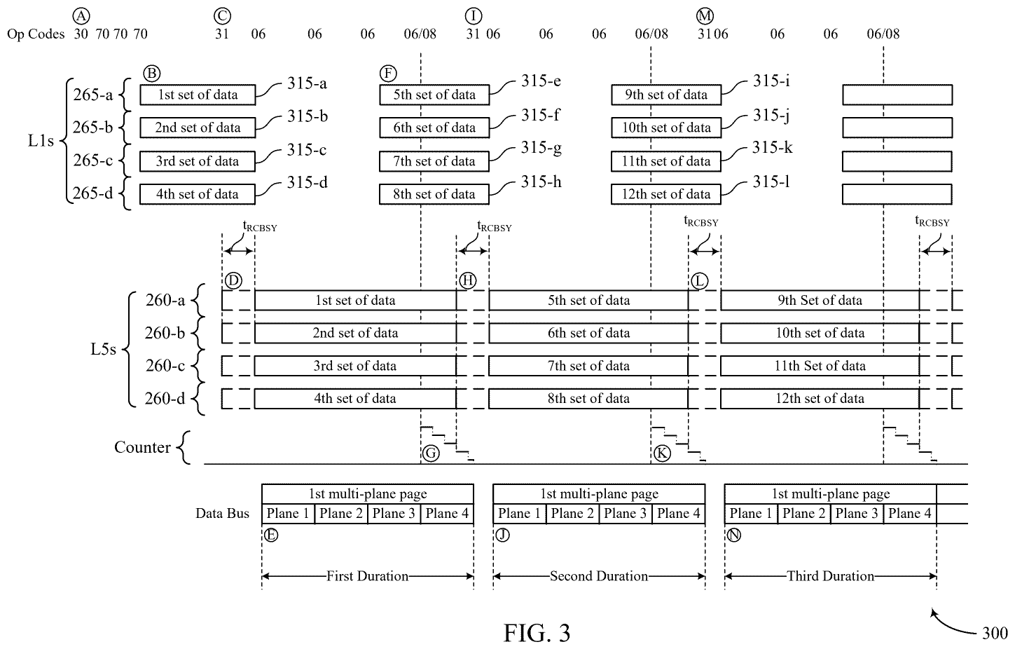

FIG. 3 shows an example of a timing diagram 300 that supports predictive transfer data register in multiplane cache read in accordance with examples as disclosed herein. The read example is based on (e.g., assumes a usage of) the memory system 200 of FIG. 2. Thus, for the purposes of the timing diagram 300, subsets of the sets of latches 255-a (gateway latches L5) and 255-b (buffer latches L1) may be used for passing pages of data. The steps that the memory system controller is responsible for may be implemented in instructions/firmware stored on a memory of memory system 200 (e.g., memory coupled with or included in memory system controller 205) and executed by the memory system controller 205. Additionally, the steps that a memory device (memory device 210-1 through 210-n) is responsible for may be implemented in instructions/firmware stored on a memory of the memory device and executed by a controller (e.g., logic 240 or a local controller, such as local controller 135-a).

At A, the memory device may receive a read memory command from the memory system controller. The read memory command may comprise one or more opcodes associated with a page and one or more planes. For example, an opcode 30h or 32h corresponding to a read memory command may be received by the memory device over an ONFI command bus.

In response to receiving the read memory command, the memory device may obtain from the planes, a first multi-plane page of data that may comprise a different portion from each plane. The portion from plane 1 may be considered a first set of data 315-a, the portion from plane 2 may be considered a second set of data 315-b, the portion from plane 3 may be considered a third set of data 315-c, and the portion from plane 4 may be considered a fourth set of data 315-d. The first, second, third, and fourth sets of data associated with the first page may respectively obtained from planes 1 through 4 and may be stored in first buffer latches 265-a, second buffer latches 265-b, third buffer latches 265-c, and fourth buffer latches 265-d, respectively. For example, at B, a first set of data 315-a may be obtained from plane 1 and stored in first buffer latches 265-a; a second set of data 315-b may be obtained from plane 2 and stored in second buffer latches 265-b; a third set of data 315-c may be obtained from plane 3 and stored in third buffer latches 265-c; and a fourth set of data 315-d may be obtained from plane 4 and stored in fourth buffer latches 265-d. This may be done concurrently for the first, second, third, and fourth sets of data.

The memory device may then receive a command from the memory system controller to transmit the first multi-plane page to the memory system controller. For example, at C, an opcode 31h may be received by the memory device over the ONFI command bus indicating to the memory device to initiate the next read operation and prepare the previous multi-plane page for transmission to the memory system controller.

In response to receiving the command, the first, second, third, and fourth sets of data are transferred from respective buffer latches to respective gateway latches. For example, at D, the first set of data 315-a may be transferred from first buffer latches 265-a to first gateway latches 260-a; the second set of data 315-b may be transferred from second buffer latches 265-b to second gateway latches 260-b; the third set of data 315-c may be transferred from third buffer latches 265-c to third gateway latches 260-c; and the fourth set of data 315-d may be transferred from fourth buffer latches 265-d to fourth gateway latches 260-d. The transfer may be done concurrently for the first, second, third, and fourth sets of data. After a wait time for completing the transfer (e.g., t_{RCBSY}), the buffer latches 265-a through 265-d may be free for receiving other data.

After the first, second, third, and fourth sets of data have been transferred to gateway latches 260-a through 260-d, the first, second, third, and fourth sets of data may be transmitted from those latches to the memory system controller, a plane at a time, with no delay between the planes. For example, beginning at E, a portion of data associated with plane 1 (e.g., the first set of data 315-a) may be transmitted over a data bus to the memory system controller from the first gateway latches 260-a over a first portion of a first duration. After the portion of data associated with plane 1 is transmitted, the portion of data associated with plane 2 (e.g., the second set of data 315-b) may be transmitted over the data bus to the memory system controller over a second portion of the first duration. The process may continue to transmit the third set of data 315-c over a third portion of the first duration and the fourth set of data 315-d over a fourth portion of the first duration. In some examples, there may be no delay between transmission of each set of data.

In some examples, the transmitting of the data associated with each plane may be based on (e.g., in direct response to) receiving a command to do so from the memory system controller. The memory system controller may send a command to the memory device after data for a first or next plane is to be transmitted. For example, an opcode 06h may be received by the memory device over the ONFI command bus to select the plane for the transmission. Thus, at E, the first set of data 315-a may be transmitted to the memory system controller based on (e.g., in direct response to) a first opcode 06h received after C and at F; the second set of data 315-b may be transmitted to the memory system controller based on (e.g., in direct response to) a second opcode 06h received after the first opcode 06h; the third set of data 315-c may be transmitted to the memory system controller based on (e.g., in direct response to) a third opcode 06h received after the second opcode 06h; and the fourth set of data 315-d may be transmitted to the memory system controller based on (e.g., in direct response to) a fourth opcode (e.g., 06h or 08h) received after the third opcode 06h.

After each of the buffer latches have become free, the memory device may obtain from the planes, a second multi-plane page of data. For example, at F, a fifth set of data 315-c may be obtained from plane 1 and stored in the first buffer latches 265-a; a sixth set of data 315-f may be obtained from plane 2 and stored in the second buffer latches 265-b; a seventh set of data 315-g may be obtained from plane 3 and stored in the third buffer latches 265-c; and an eighth set of data 315-h may be obtained from plane 4 and stored in the fourth buffer latches 265-d.

Once the fourth opcode (e.g., 06h or 08h) is received, the memory device at G may initialize a counter with a size of data to be transferred (e.g., an amount of data to be transferred from the fourth gateway latches 260-d). As the fourth gateway latches 260-d transmit data to the memory system controller, the value of the counter may be adjusted (e.g., decreased) accordingly. In some examples, the counter may be initialized based on (e.g., in direct response to) the fourth opcode indicating that the data of plane 4 (e.g., the fourth set of data 315-d) is to be transmitted from the fourth gateway latches 260-d. This indication may be provided via a reserved bit of 06h (e.g., via a toggled bit) or may be indicated via reception of the 08h.

Once the counter reaches a threshold value at H, the memory device may initiate the wait time (e.g., t_{RCBSY}) for transferring the fifth set of data 315-e through the eighth set of data 315-h from the buffer latches 265-a through 265-d, respectively, to the gateway latches 260-a through 260-d, respectively. The value of the threshold may be set such that any remaining bits of the fourth set of data 315-d are transmitted to the memory system controller before the eighth set of data 315-h is transferred from fourth buffer latches 265-d to fourth gateway latches 260-d.

After initiating the wait time, the memory device may receive a command to transmit a second multi-plane page to the memory system controller. For example, at I, an opcode 31h may be received by the memory device over the ONFI command bus indicating to the memory device to initiate the next read operation in which the second multi-plane page is to be transferred. Due to the wait time being initiated at H prior to receiving the command at I, the corresponding transfer from the buffer latches to the gateway latches may be referred to as a predictive transfer. In some examples, the wait time (e.g., t_{RCBSY}) may finish before the end of the fourth portion of the first duration for transferring the fourth set of data 315-d. Alternatively, the wait time may finish before receiving the command at I. Alternatively, the wait time may continue after receiving the command but may finish before the memory device receives a command to transmit the fifth set of data 315-e from the first gateway latches 260-a (e.g., an 06h command). It should be noted that, in some cases, the memory device may not receive the 31h command. Instead, in such cases, the memory device may receive a poll for a status update indicating the transfer is complete and may provide the corresponding indication (e.g., after t_{RCBSY}). Alternatively, the memory device may receive the 31h command and also undergo polling.

After receiving the command to transmit the second multi-plane page, the fifth, sixth, seventh, and eighth sets of data are transferred from respective buffer latches to respective gateway latches. For instance, the fifth set of data 315-e may be transferred from first buffer latches 265-a to first gateway latches 260-a; the sixth set of data 315-f may be transferred from second buffer latches 265-b to second gateway latches 260-b; the seventh set of data 315-g may be transferred from third buffer latches 265-c to third gateway latches 260-c; and the eighth set of data 315-h may be transferred from fourth buffer latches 265-d to fourth gateway latches 260-d. The transfer may be done concurrently for the fifth, sixth, seventh, and eighth sets of data. After the wait time for completing the transfer (e.g., t_{RCBSY}), the buffer latches 265-a through 265-d may be free for receiving other data.

After the fifth, sixth, seventh, and eighth sets of data have been transferred to gateway latches 260-e through 260-h, the fifth, sixth, seventh, and eighth sets of data may be transmitted from those latches to the memory system controller, a plane at a time, with no delay between the planes. For example, beginning at J, a portion of data associated with plane 1 (e.g., the fifth set of data 315-e) may be transmitted over a data bus to the memory system controller from the first gateway latches 260-a over a first portion of a second duration. After the portion of data associated with plane 1 is transmitted, the portion of data associated with plane 2 (e.g., the sixth set of data 315-f) may be transmitted over the data bus to the memory system controller over a second portion of the second duration. The process may continue to transmit the seventh set of data 315-g over a third portion of the second duration and the eighth set of data 315-h over a fourth portion of the second duration. In some examples, there may be no delay between transmission of each set of data.

As the wait time for completing the transfer (e.g., t_{RCBSY}) begins prior to 31h, the amount of time between the 31h command being received at I and the portion of data associated with plane 1 (e.g., the fifth set of data 315-e) being transmitted over the data bus at J may be reduced as compared to beginning the wait time at or after 31h. Additionally, or alternatively, an amount of time before the memory device begins polling for a status of the gateway latches (e.g., at the end of t_{RCBSY}) may be reduced. In some examples, it should be noted that no gap between I and J may be present (e.g., in examples in which the wait time completes before I).

The fifth set of data 315-e may be transmitted to the memory system controller based on (e.g., in direct response to) a first opcode 06h received after I; the sixth set of data 315-f may be transmitted to the memory system controller based on (e.g., in direct response to) a second opcode 06h received after the first opcode 06h; the seventh set of data 315-g may be transmitted to the memory system controller based on (e.g., in direct response to) a third opcode 06h received after the second opcode 06h; and the eighth set of data 315-h may be transmitted to the memory system controller based on (e.g., in direct response to) a fourth opcode (e.g., 06h or 08h) received after the third opcode 06h.

After each of the buffer latches have become free, the memory device may obtain from the planes, a third multi-plane page of data. For example, a ninth set of data 315-i may be obtained from plane 1 and stored in the first buffer latches 265-a; a tenth set of data 315-j may be obtained from plane 2 and stored in the second buffer latches 265-b; an eleventh set of data 315-k may be obtained from plane 3 and stored in the third buffer latches 265-c; and a twelfth set of data 315-l may be obtained from plane 4 and stored in the fourth buffer latches 265-d.

Once the fourth opcode (e.g., 06h or 08h) is received, the memory device at K may re-initialize a counter with a size of data to be transferred (e.g., an amount of data to be transferred from the fourth gateway latches 260-d). As the fourth gateway latches 260-d transmit data to the memory system controller, the value of the counter may be adjusted (e.g., decreased) accordingly. In some examples, the counter may be initialized based on (e.g., in direct response to) the fourth opcode indicating that the data of plane 4 (e.g., the eighth set of data 315-h) is to be transmitted from the fourth gateway latches 260-d. This indication may be provided via a reserved bit of 06h (e.g., via a toggled bit) or may be indicated via reception of the 08h.

Once the counter reaches a threshold value at L, the memory device may initiate the wait time (e.g., t_{RCBSY}) for transferring the ninth set of data 315-i through the twelfth set of data 315-l from the buffer latches 265-a through 265-d, respectively, to the gateway latches 260-a through 260-d, respectively. The value of the threshold may be set such that any remaining bits of the eighth set of data 315-h are transmitted to the memory system controller before the twelfth set of data 315-l is transferred from fourth buffer latches 265-d to fourth gateway latches 260-d.

After initiating the wait time, the memory device may receive a command to transmit a second multi-plane page to the memory system controller. For example, at M, an opcode 31h may be received by the memory device over the ONFI command bus indicating to the memory device to initiate the next read operation in which the third multi-plane page is to be transferred. In some examples, the wait time (e.g., t_{RCBSY}) may finish before the end of the fourth portion of the second duration for transferring the eighth set of data 315-h. Alternatively, the wait time may finish before receiving the command. Alternatively, the wait time may continue after receiving the command but may finish before the memory device receives a command to transmit the ninth set of data 315-i from the first gateway latches 260-a. It should be noted that, in some cases, the memory device may not receive the command. Instead, in such cases, the memory device may receive a poll for a status update indicating the transfer is complete and may provide the corresponding indication (e.g., after t_{RCBSY}).

After receiving the command to transmit the third multi-plane page, the ninth, tenth, eleventh, and twelfth sets of data are transferred from respective buffer latches to respective gateway latches. For instance, the ninth set of data 315-i may be transferred from first buffer latches 265-a to first gateway latches 260-a; the tenth set of data 315-j may be transferred from second buffer latches 265-b to second gateway latches 260-b; the eleventh set of data 315-k may be transferred from third buffer latches 265-c to third gateway latches 260-c; and the twelfth set of data 315-l may be transferred from fourth buffer latches 265-d to fourth gateway latches 260-d. The transfer may be done concurrently for the ninth, tenth, eleventh, and twelfth sets of data. After the wait time for completing the transfer (e.g., t_{RCBSY}), the buffer latches 265-a through 265-d may be free for receiving other data.

After the ninth, tenth, eleventh, and twelfth sets of data have been transferred to gateway latches 260-e through 260-h, the ninth, tenth, eleventh, and twelfth sets of data may be transmitted from those latches to the memory system controller, a plane at a time, with no delay between the planes. For example, beginning at N, a portion of data associated with plane 1 (e.g., the ninth set of data 315-i) may be transmitted over a data bus to the memory system controller from the first gateway latches 260-a over a first portion of a third duration. After the portion of data associated with plane 1 is transmitted, the portion of data associated with plane 2 (e.g., the tenth set of data 315-j) may be transmitted over the data bus to the memory system controller over a second portion of the third duration. The process may continue to transmit the eleventh set of data 315-k over a third portion of the third duration and the twelfth set of data 315-l over a fourth portion of the third duration. In some examples, there may be no delay between transmission of each set of data.

As the wait time for completing the transfer (e.g., t_{RCBSY}) begins prior to 31h, the amount of time between the 31h command being received at M and the portion of data associated with plane 1 (e.g., the ninth set of data 315-i) being transmitted over the data bus at N may be reduced as compared to beginning the wait time at or after 31h. Additionally, or alternatively, an amount of time before the memory device begins polling for a status of the gateway latches (e.g., at the end of t_{RCBSY}) may be reduced. In some examples, it should be noted that no gap between M and N may be present (e.g., in examples in which the wait time completes before M).

Although the depicted example shows three multi-plane pages of data associated with the read command, any number of pages may instead be transmitted. For example, steps K-N may be omitted, or more than three pages may also be transmitted. Each additional page may be handled in a similar manner to the first, second, and third pages. That is, for each additional page, the transferring of the data sets from the set of buffer latches to the set of gateway latches may be offset for the different subsets of planes. For example, steps K-N may be repeated for each additional page.

Although parallel transfer is depicted herein (e.g., t_{RCBSY} starts at a same time for each of planes 1 through 4), it should be noted that there may be examples in which non-parallel or staggered transfer is employed. For instance, at a first threshold of the counter (e.g., T[1]), the memory device may initiate the wait time for a first subset of the planes (e.g., planes 1 and 2) and at a second threshold of the counter (e.g., T[0]), the memory device may initiate the wait time for a second subset of the planes (e.g., planes 3 and 4).

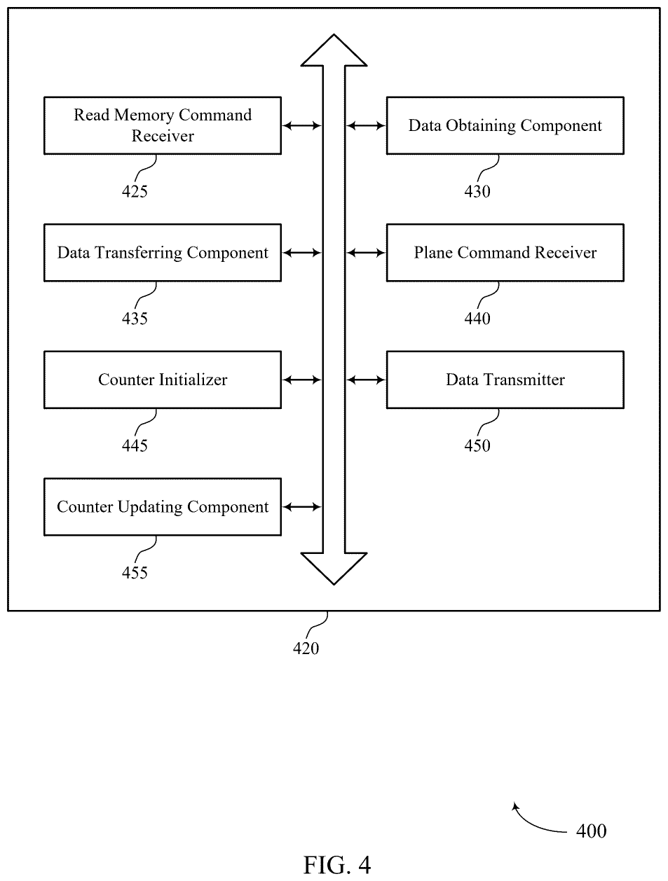

FIG. 4 shows a block diagram 400 of a memory system 420 that supports predictive transfer data register in multiplane cache read in accordance with examples as disclosed herein. The memory system 420 may be an example of aspects of a memory system as described with reference to FIGS. 1 through 3. The memory system 420, or various components thereof, may be an example of means for performing various aspects of predictive transfer NAND data register in multiplane cache read as described herein. For example, the memory system 420 may include a read memory command receiver 425, a data obtaining component 430, a data transferring component 435, a plane command receiver 440, a counter initializer 445, a data transmitter 450, a counter updating component 455, or any combination thereof. Each of these components, or components of subcomponents thereof (e.g., one or more processors, one or more memories), may communicate, directly or indirectly, with one another (e.g., via one or more buses).

The read memory command receiver 425 may be configured as or otherwise support a means for receiving, at the memory device, a read memory command associated with a plurality of pages and a plurality of planes. The data obtaining component 430 may be configured as or otherwise support a means for obtaining, from memory of the memory device, a first set of data associated with a first page of the plurality of pages and with the plurality of planes, the obtaining the first set of data including loading the first set of data into a first set of latches. The data transferring component 435 may be configured as or otherwise support a means for transferring the first set of data from the first set of latches to a second set of latches. In some examples, the data obtaining component 430 may be configured as or otherwise support a means for obtaining, from the memory of the memory device after transferring the first set of data from the first set of latches to the second set of latches, a second set of data associated with a second page of the plurality of pages and with the plurality of planes, where the obtaining the second set of data includes loading the second set of data into the first set of latches. The plane command receiver 440 may be configured as or otherwise support a means for receiving a plurality of commands, where each of the plurality of commands indicates to transmit a respective subset of the first set of data associated with the first page for a respective plane of the plurality of planes. The counter initializer 445 may be configured as or otherwise support a means for initializing a counter to a first value based at least in part on receiving a quantity of commands of the plurality of commands. The data transmitter 450 may be configured as or otherwise support a means for transmitting, in response to receiving the plurality of commands, the first set of data from the second set of latches. The counter updating component 455 may be configured as or otherwise support a means for updating the counter based at least in part on a quantity of the first set of data transmitted subsequent to initializing the counter. In some examples, the data transferring component 435 may be configured as or otherwise support a means for transferring the second set of data from the first set of latches to the second set of latches based at least in part on the counter satisfying a threshold.

In some examples, the plurality of commands includes a plurality of transfer commands. In some examples, initializing the counter is based at least in part on a last transfer command of the plurality of transfer commands for a quantity of planes of the plurality of planes.

In some examples, initializing the counter is based at least in part on the last transfer command being a separate type of transfer command from each other transfer command of the plurality of transfer commands.

In some examples, initializing the counter is based at least in part on an indicator of a field of the last transfer command.

In some examples, the counter satisfying the threshold includes an updated value of the counter indicating that the quantity of the first set of data transmitted is at least equal to a respective threshold amount.

In some examples, the first and second pages correspond to pages of multi-level cells of the memory device.

In some examples, the first set of data and the second set of data are obtained from a NOT-AND (NAND) memory of the memory device.

In some examples, to support transferring the second set of data from the first set of latches to the second set of latches, the data transferring component 435 may be configured as or otherwise support a means for transferring a first subset of the second set of data associated with a first subset of the plurality of planes from a first subset of the first set of latches to a first subset of the second set of latches based at least in part on the second value of the counter satisfying the threshold. In some examples, to support transferring the second set of data from the first set of latches to the second set of latches, the counter updating component 455 may be configured as or otherwise support a means for updating the counter to a third value based at least in part on a second quantity of the second set of data transmitted subsequent to updating the counter to the second value. In some examples, to support transferring the second set of data from the first set of latches to the second set of latches, the data transferring component 435 may be configured as or otherwise support a means for transferring a second subset of the second set of data associated with a second subset of the plurality of planes from a second subset of the first set of latches to a second subset of the second set of latches based at least in part on the third value of the counter satisfying a second threshold.

In some examples, the data obtaining component 430 may be configured as or otherwise support a means for obtaining, from the memory of the memory device after transferring the second set of data from the first set of latches to the second set of latches, a third set of data associated with a third page of the plurality of pages and with the plurality of planes, where the obtaining the third set of data includes loading the third set of data into the first set of latches. In some examples, the plane command receiver 440 may be configured as or otherwise support a means for receiving a plurality of second commands, where each of the plurality of second commands indicates to transmit a respective subset of the second set of data associated with the second page for a respective plane of the plurality of planes. In some examples, the counter initializer 445 may be configured as or otherwise support a means for reinitializing the counter to the first value based at least in part on receiving a quantity of second commands of the plurality of second commands. In some examples, the data transmitter 450 may be configured as or otherwise support a means for transmitting, in response to receiving the plurality of second commands, the second set of data from the second set of latches. In some examples, the counter updating component 455 may be configured as or otherwise support a means for updating the counter based at least in part on a quantity of the second set of data transmitted subsequent to initializing the counter. In some examples, the data transferring component 435 may be configured as or otherwise support a means for transferring the third set of data from the first set of latches to the second set of latches based at least in part on the counter satisfying the threshold.

In some examples, the plurality of commands includes a plurality of transfer commands. In some examples, initializing the counter is based at least in part on a last transfer command of the plurality of transfer commands for a quantity of planes of the plurality of planes.

In some examples, initializing the counter is based at least in part on the last transfer command being a separate type of transfer command from each other transfer command of the plurality of transfer commands.

In some examples, initializing the counter is based at least in part on an indicator of a field of the last transfer command.

In some examples, the counter satisfying the threshold includes an updated value of the counter indicating that the quantity of the first set of data transmitted is at least equal to a respective threshold amount.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

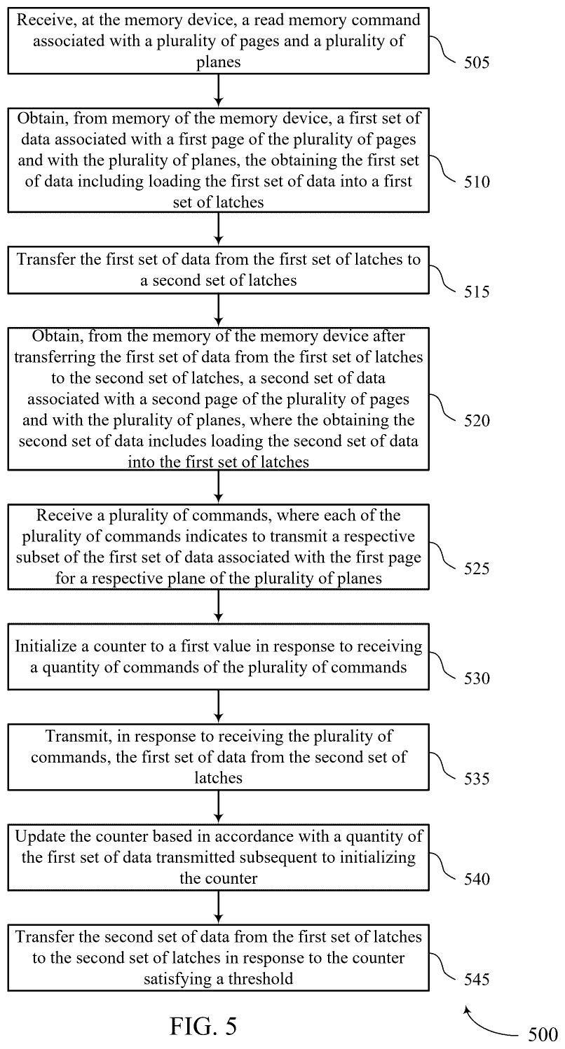

FIG. 5 shows a flowchart illustrating a process 500 that supports predictive transfer data register in multiplane cache read in accordance with examples as disclosed herein. The operations of process 500 may be implemented by a memory system or its components as described herein. For example, the operations of process 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware. Additionally, or alternatively, aspects of the process 500 may be implemented by one or more controllers, among other components. Additionally, or alternatively, aspects of the process 500 may be implemented as instructions stored in one or more memories (e.g., firmware stored in one or more memories coupled with memory system controller 205). For example, the instructions, when executed by one or more controllers (e.g., the memory system controller 205), may cause the one or more controllers (or a device or a system) to perform the operations of the process 500.

At 505, the method may include receiving, at the memory device, a read memory command associated with a plurality of pages and a plurality of planes. In some examples, aspects of the operations of 505 may be performed by a read memory command receiver 425 as described with reference to FIG. 4.

At 510, the method may include obtaining, from memory of the memory device, a first set of data associated with a first page of the plurality of pages and with the plurality of planes, the obtaining the first set of data including loading the first set of data into a first set of latches. In some examples, aspects of the operations of 510 may be performed by a data obtaining component 430 as described with reference to FIG. 4.

At 515, the method may include transferring the first set of data from the first set of latches to a second set of latches. In some examples, aspects of the operations of 515 may be performed by a data transferring component 435 as described with reference to FIG. 4.

At 520, the method may include obtaining, from the memory of the memory device after transferring the first set of data from the first set of latches to the second set of latches, a second set of data associated with a second page of the plurality of pages and with the plurality of planes, where the obtaining the second set of data includes loading the second set of data into the first set of latches. In some examples, aspects of the operations of 520 may be performed by a data obtaining component 430 as described with reference to FIG. 4.

At 525, the method may include receiving a plurality of commands, where each of the plurality of commands indicates to transmit a respective subset of the first set of data associated with the first page for a respective plane of the plurality of planes. In some examples, aspects of the operations of 525 may be performed by a plane command receiver 440 as described with reference to FIG. 4.

At 530, the method may include initializing a counter to a first value based at least in part on receiving a quantity of commands of the plurality of commands. In some examples, aspects of the operations of 530 may be performed by a counter initializer 445 as described with reference to FIG. 4.

At 535, the method may include transmitting, in response to receiving the plurality of commands, the first set of data from the second set of latches. In some examples, aspects of the operations of 535 may be performed by a data transmitter 450 as described with reference to FIG. 4.

At 540, the method may include updating the counter based at least in part on a quantity of the first set of data transmitted subsequent to initializing the counter. In some examples, aspects of the operations of 540 may be performed by a counter updating component 455 as described with reference to FIG. 4.

At 545, the method may include transferring the second set of data from the first set of latches to the second set of latches based at least in part on the counter satisfying a threshold. In some examples, aspects of the operations of 545 may be performed by a data transferring component 435 as described with reference to FIG. 4.

In some examples, an apparatus as described herein may perform a method or methods, such as the process 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at the memory device, a read memory command associated with a plurality of pages and a plurality of planes; obtaining, from memory of the memory device, a first set of data associated with a first page of the plurality of pages and with the plurality of planes, the obtaining the first set of data including loading the first set of data into a first set of latches; transferring the first set of data from the first set of latches to a second set of latches; obtaining, from the memory of the memory device after transferring the first set of data from the first set of latches to the second set of latches, a second set of data associated with a second page of the plurality of pages and with the plurality of planes, where the obtaining the second set of data includes loading the second set of data into the first set of latches; receiving a plurality of commands, where each of the plurality of commands indicates to transmit a respective subset of the first set of data associated with the first page for a respective plane of the plurality of planes; initializing a counter to a first value in response to receiving a quantity of commands of the plurality of commands; transmitting, in response to receiving the plurality of commands, the first set of data from the second set of latches; updating the counter in accordance with a quantity of the first set of data transmitted subsequent to initializing the counter; and transferring the second set of data from the first set of latches to the second set of latches in response to the counter satisfying a threshold.

Aspect 2: The method, apparatus, or non-transitory computer-readable medium of aspect 1, where the plurality of commands includes a plurality of transfer commands and initializing the counter is in response to the plurality of transfer commands comprising a last transfer command for a quantity of planes of the plurality of planes.

Aspect 3: The method, apparatus, or non-transitory computer-readable medium of aspect 2, where initializing the counter is in response to the last transfer command being a separate type of transfer command from each other transfer command of the plurality of transfer commands.

Aspect 4: The method, apparatus, or non-transitory computer-readable medium of any of aspects 2 through 3, where initializing the counter is in response to an indicator of a field of the last transfer command.

Aspect 5: The method, apparatus, or non-transitory computer-readable medium of any of aspects 1 through 4, where the counter satisfying the threshold includes an updated value of the counter indicating that the quantity of the first set of data transmitted is at least equal to a respective threshold amount.

Aspect 6: The method, apparatus, or non-transitory computer-readable medium of any of aspects 1 through 5, where the first and second pages correspond to pages of multi- level cells of the memory device.

Aspect 7: The method, apparatus, or non-transitory computer-readable medium of any of aspects 1 through 6, where the first set of data and the second set of data are obtained from a NOT-AND (NAND) memory of the memory device.

Aspect 8: The method, apparatus, or non-transitory computer-readable medium of any of aspects 1 through 7, where transferring the second set of data from the first set of latches to the second set of latches includes operations, features, circuitry, logic, means, or instructions, or any combination thereof for transferring a first subset of the second set of data associated with a first subset of the plurality of planes from a first subset of the first set of latches to a first subset of the second set of latches in response to the second value of the counter satisfying the threshold; updating the counter to a third value in accordance with a second quantity of the second set of data transmitted subsequent to updating the counter to the second value; and transferring a second subset of the second set of data associated with a second subset of the plurality of planes from a second subset of the first set of latches to a second subset of the second set of latches in response to the third value of the counter satisfying a second threshold.

Aspect 9: The method, apparatus, or non-transitory computer-readable medium of any of aspects 1 through 8, further including operations, features, circuitry, logic, means, or instructions, or any combination thereof for obtaining, from the memory of the memory device after transferring the second set of data from the first set of latches to the second set of latches, a third set of data associated with a third page of the plurality of pages and with the plurality of planes, where the obtaining the third set of data includes loading the third set of data into the first set of latches; receiving a plurality of second commands, where each of the plurality of second commands indicates to transmit a respective subset of the second set of data associated with the second page for a respective plane of the plurality of planes; reinitializing the counter to the first value in response to receiving a quantity of second commands of the plurality of second commands; transmitting, in response to receiving the plurality of second commands, the second set of data from the second set of latches; updating the counter in accordance with a quantity of the second set of data transmitted subsequent to initializing the counter; and transferring the third set of data from the first set of latches to the second set of latches in response to the counter satisfying the threshold.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 10: A memory device, including: processing circuitry coupled with memory of the memory device and configured to cause the memory device to: receive, at the memory device, a read memory command associated with a plurality of pages and a plurality of planes; obtain, from the memory of the memory device, a first set of data associated with a first page of the plurality of pages and with the plurality of planes, the obtaining the first set of data including loading the first set of data into a first set of latches; transfer the first set of data from the first set of latches to a second set of latches; obtain, from the memory of the memory device after transferring the first set of data from the first set of latches to the second set of latches, a second set of data associated with a second page of the plurality of pages and with the plurality of planes, where the obtaining the second set of data includes loading the second set of data into the first set of latches; receive a plurality of commands, where each of the plurality of commands indicates to transmit a respective subset of the first set of data associated with the first page for a respective plane of the plurality of planes; initialize a counter to a first value in response to receiving a quantity of commands of the plurality of commands; transmit, in response to receiving the plurality of commands, the first set of data from the second set of latches; update the counter in accordance with a quantity of the first set of data transmitted subsequent to initializing the counter; and transfer the second set of data from the first set of latches to the second set of latches in response to the counter satisfying a threshold.

Aspect 11: The memory device of aspect 10, where: the plurality of commands includes a plurality of transfer commands, and initializing the counter is in response to the plurality of transfer commands comprising a last transfer command for a quantity of planes of the plurality of planes.

Aspect 12: The memory device of aspect 11, where initializing the counter is in response to the last transfer command being a separate type of transfer command from each other transfer command of the plurality of transfer commands.

Aspect 13: The memory device of any of aspects 11 through 12, where initializing the counter is in response to an indicator of a field of the last transfer command.

Aspect 14: The memory device of any of aspects 10 through 13, where the counter satisfying the threshold includes an updated value of the counter indicating that the quantity of the first set of data transmitted is at least equal to a respective threshold amount.

Aspect 15: The memory device of any of aspects 10 through 14, where the first and second pages correspond to pages of multi-level cells of the memory device.

Aspect 16: The memory device of any of aspects 10 through 15, where the first set of data and the second set of data are obtained from a NOT-AND (NAND) memory of the memory device.

Aspect 17: The memory device of any of aspects 10 through 16, where updating the counter includes updating the counter to a second value, and where, to transfer the second set of data from the first set of latches to the second set of latches, the processing circuitry is configured to cause the memory device to: transfer a first subset of the second set of data associated with a first subset of the plurality of planes from a first subset of the first set of latches to a first subset of the second set of latches in response to the second value of the counter satisfying the threshold; update the counter to a third value in accordance with a second quantity of the second set of data transmitted subsequent to updating the counter to the second value; and transfer a second subset of the second set of data associated with a second subset of the plurality of planes from a second subset of the first set of latches to a second subset of the second set of latches in response to the third value of the counter satisfying a second threshold.

Aspect 18: The memory device of any of aspects 10 through 17, where the processing circuitry is further configured to cause the memory device to: obtain, from the memory of the memory device after transferring the second set of data from the first set of latches to the second set of latches, a third set of data associated with a third page of the plurality of pages and with the plurality of planes, where the obtaining the third set of data includes loading the third set of data into the first set of latches; receive a plurality of second commands, where each of the plurality of second commands indicates to transmit a respective subset of the second set of data associated with the second page for a respective plane of the plurality of planes; reinitialize the counter to the first value in response to receiving a quantity of second commands of the plurality of second commands; transmit, in response to receiving the plurality of second commands, the second set of data from the second set of latches; update the counter in accordance with a quantity of the second set of data transmitted subsequent to initializing the counter; and transfer the third set of data from the first set of latches to the second set of latches in response to the counter satisfying the threshold.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on (e.g., dependent on) the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
processing circuitry coupled with memory of the memory device and configured to cause the memory device to:
receive, at the memory device, a read memory command associated with a plurality of pages and a plurality of planes;
obtain, from the memory of the memory device, a first set of data associated with a first page of the plurality of pages and with the plurality of planes, the obtaining the first set of data comprising loading the first set of data into a first set of latches;
transfer the first set of data from the first set of latches to a second set of latches;
obtain, from the memory of the memory device after transferring the first set of data from the first set of latches to the second set of latches, a second set of data associated with a second page of the plurality of pages and with the plurality of planes, wherein the obtaining the second set of data comprises loading the second set of data into the first set of latches;
receive a plurality of commands, wherein each of the plurality of commands indicates to transmit a respective subset of the first set of data associated with the first page for a respective plane of the plurality of planes;
initialize a counter to a first value in response to receiving a quantity of commands of the plurality of commands;
transmit, in response to receiving the plurality of commands, the first set of data from the second set of latches;
update the counter in accordance with a quantity of the first set of data transmitted subsequent to initializing the counter; and
transfer the second set of data from the first set of latches to the second set of latches in response to the counter satisfying a threshold.

2. The memory device of claim 1, wherein:
the plurality of commands comprises a plurality of transfer commands, and
initializing the counter is in response to the plurality of transfer commands comprising a last transfer command for a quantity of planes of the plurality of planes.

3. The memory device of claim 2, wherein initializing the counter is in response to the last transfer command being a separate type of transfer command from each other transfer command of the plurality of transfer commands.

4. The memory device of claim 2, wherein initializing the counter is in response to an indicator of a field of the last transfer command.

5. The memory device of claim 1, wherein the counter satisfying the threshold comprises an updated value of the counter indicating that the quantity of the first set of data transmitted is at least equal to a respective threshold amount.

6. The memory device of claim 1, wherein the first and second pages correspond to pages of multi-level cells of the memory device.

7. The memory device of claim 1, wherein the first set of data and the second set of data are obtained from a NOT-AND (NAND) memory of the memory device.

8. The memory device of claim 1, wherein updating the counter comprises updating the counter to a second value, and wherein, to transfer the second set of data from the first set of latches to the second set of latches, the processing circuitry is configured to cause the memory device to:
transfer a first subset of the second set of data associated with a first subset of the plurality of planes from a first subset of the first set of latches to a first subset of the second set of latches in response to the second value of the counter satisfying the threshold;
update the counter to a third value in accordance with a second quantity of the second set of data transmitted subsequent to updating the counter to the second value; and
transfer a second subset of the second set of data associated with a second subset of the plurality of planes from a second subset of the first set of latches to a second subset of the second set of latches in response to the third value of the counter satisfying a second threshold.

9. The memory device of claim 1, wherein the processing circuitry is further configured to cause the memory device to:
obtain, from the memory of the memory device after transferring the second set of data from the first set of latches to the second set of latches, a third set of data associated with a third page of the plurality of pages and with the plurality of planes, wherein the obtaining the third set of data comprises loading the third set of data into the first set of latches;
receive a plurality of second commands, wherein each of the plurality of second commands indicates to transmit a respective subset of the second set of data associated with the second page for a respective plane of the plurality of planes;
reinitialize the counter to the first value in response to receiving a quantity of second commands of the plurality of second commands;
transmit, in response to receiving the plurality of second commands, the second set of data from the second set of latches;
update the counter in accordance with a quantity of the second set of data transmitted subsequent to initializing the counter; and
transfer the third set of data from the first set of latches to the second set of latches based at least in part on the counter satisfying the threshold.

10. A non-transitory computer-readable medium storing code comprising instructions which, when executed by one or more processors of a memory device, cause the memory device to:
receive, at the memory device, a read memory command associated with a plurality of pages and a plurality of planes;
obtain, from memory of the memory device, a first set of data associated with a first page of the plurality of pages and with the plurality of planes, the obtaining the first set of data comprising loading the first set of data into a first set of latches;
transfer the first set of data from the first set of latches to a second set of latches;
obtain, from the memory of the memory device after transferring the first set of data from the first set of latches to the second set of latches, a second set of data associated with a second page of the plurality of pages and with the plurality of planes, wherein the obtaining the second set of data comprises loading the second set of data into the first set of latches;
receive a plurality of commands, wherein each of the plurality of commands indicates to transmit a respective subset of the first set of data associated with the first page for a respective plane of the plurality of planes;
initialize a counter to a first value in response to receiving a quantity of commands of the plurality of commands;
transmit, in response to receiving the plurality of commands, the first set of data from the second set of latches;
update the counter in accordance with a quantity of the first set of data transmitted subsequent to initializing the counter; and
transfer the second set of data from the first set of latches to the second set of latches in response to the counter satisfying a threshold.

11. The non-transitory computer-readable medium of claim 10, wherein the instructions, when executed by the one or more processors of the memory device, further cause the memory device to:
obtain, from the memory of the memory device after transferring the second set of data from the first set of latches to the second set of latches, a third set of data associated with a third page of the plurality of pages and with the plurality of planes, wherein the obtaining the third set of data comprises loading the third set of data into the first set of latches;
receive a plurality of second commands, wherein each of the plurality of second commands indicates to transmit a respective subset of the second set of data associated with the second page for a respective plane of the plurality of planes;
reinitialize the counter to the first value in response to receiving a quantity of second commands of the plurality of second commands;
transmit, in response to receiving the plurality of second commands, the second set of data from the second set of latches;
update the counter in accordance with a quantity of the second set of data transmitted subsequent to initializing the counter; and
transfer the third set of data from the first set of latches to the second set of latches in response to the counter satisfying the threshold.

12. The non-transitory computer-readable medium of claim 10, wherein updating the counter comprises updating the counter to a second value, and wherein the instructions to transfer the second set of data from the first set of latches to the second set of latches, when executed by the one or more processors of the memory device, further cause the memory device to:
transfer a first subset of the second set of data associated with a first subset of the plurality of planes from a first subset of the first set of latches to a first subset of the second set of latches in response to the second value of the counter satisfying the threshold;
update the counter to a third value in accordance with a second quantity of the second set of data transmitted subsequent to updating the counter to the second value; and
transfer a second subset of the second set of data associated with a second subset of the plurality of planes from a second subset of the first set of latches to a second subset of the second set of latches in response to the third value of the counter satisfying a second threshold.

13. The non-transitory computer-readable medium of claim 10, wherein:
the plurality of commands comprises a plurality of transfer commands, and
initializing the counter is in response to the plurality of transfer commands comprising a last transfer command for a quantity of planes of the plurality of planes.

14. The non-transitory computer-readable medium of claim 13, wherein initializing the counter is in response to the last transfer command being a separate type of transfer command from each other transfer command of the plurality of transfer commands.

15. The non-transitory computer-readable medium of claim 13, wherein initializing the counter is in response to an indicator of a field of the last transfer command.

16. The non-transitory computer-readable medium of claim 10, wherein the counter satisfying the threshold comprises an updated value of the counter indicating that the quantity of the first set of data transmitted is at least equal to a respective threshold amount.

17. The non-transitory computer-readable medium of claim 10, wherein the first and second pages correspond to pages of multi-level cells of the memory device.

18. The non-transitory computer-readable medium of claim 10, wherein the first set of data and the second set of data are obtained from a NOT-AND (NAND) memory of the memory device.

19. A method at a memory device, comprising:
receiving, at the memory device, a read memory command associated with a plurality of pages and a plurality of planes;
obtaining, from memory of the memory device, a first set of data associated with a first page of the plurality of pages and with the plurality of planes, the obtaining the first set of data comprising loading the first set of data into a first set of latches;
transferring the first set of data from the first set of latches to a second set of latches;
obtaining, from the memory of the memory device after transferring the first set of data from the first set of latches to the second set of latches, a second set of data associated with a second page of the plurality of pages and with the plurality of planes, wherein the obtaining the second set of data comprises loading the second set of data into the first set of latches;
receiving a plurality of commands, wherein each of the plurality of commands indicates to transmit a respective subset of the first set of data associated with the first page for a respective plane of the plurality of planes;
initializing a counter to a first value in response to receiving a quantity of commands of the plurality of commands;
transmitting, in response to receiving the plurality of commands, the first set of data from the second set of latches;
updating the counter in accordance with a quantity of the first set of data transmitted subsequent to initializing the counter; and
transferring the second set of data from the first set of latches to the second set of latches in response to the counter satisfying a threshold.

20. The method of claim 19, wherein:
the plurality of commands comprises a plurality of transfer commands, and
initializing the counter is in response to the plurality of transfer commands comprising a last transfer command for a quantity of planes of the plurality of planes.

21. The method of claim 20, wherein initializing the counter is in response to the last transfer command being a separate type of transfer command from each other transfer command of the plurality of transfer commands.

22. The method of claim 20, wherein initializing the counter is in response to an indicator of a field of the last transfer command.

23. The method of claim 19, wherein the counter satisfying the threshold comprises an updated value of the counter indicating that the quantity of the first set of data transmitted is at least equal to a respective threshold amount.

24. The method of claim 19, wherein updating the counter comprises updating the counter to a second value, and wherein transferring the second set of data from the first set of latches to the second set of latches comprises:
transferring a first subset of the second set of data associated with a first subset of the plurality of planes from a first subset of the first set of latches to a first subset of the second set of latches in response to the second value of the counter satisfying the threshold;
updating the counter to a third value in accordance with a second quantity of the second set of data transmitted subsequent to updating the counter to the second value; and
transferring a second subset of the second set of data associated with a second subset of the plurality of planes from a second subset of the first set of latches to a second subset of the second set of latches in response to the third value of the counter satisfying a second threshold.

25. The method of claim 19, further comprising:
obtaining, from the memory of the memory device after transferring the second set of data from the first set of latches to the second set of latches, a third set of data associated with a third page of the plurality of pages and with the plurality of planes, wherein the obtaining the third set of data comprises loading the third set of data into the first set of latches;
receiving a plurality of second commands, wherein each of the plurality of second commands indicates to transmit a respective subset of the second set of data associated with the second page for a respective plane of the plurality of planes;
reinitializing the counter to the first value in response to receiving a quantity of second commands of the plurality of second commands;
transmitting, in response to receiving the plurality of second commands, the second set of data from the second set of latches;
updating the counter in accordance with a quantity of the second set of data transmitted subsequent to initializing the counter; and
transferring the third set of data from the first set of latches to the second set of latches in response to the counter satisfying the threshold.
